(19) United States
(12) Patent Application Publication
(10) Pub. No.: US 2007/0209847 A1
(43) Pub. Date: Sep. 13, 2007

(54) Motorized hauling apparatus with drive tracks

(76) Inventors: Kevin L. Schultz, Lake Ariel, PA (US); Mark Parry, Madison Township, PA (US)

Correspondence Address: L. ZALE PATENT LAW OFFICE, 334 SOUTH FRANKLIN ST., WILKES-BARRE, PA, 18702, US

(21) Appl. No.: 11/373,079

(22) Filed: Mar. 10, 2006

(51) Int. Cl. B60K 1/00

(52) U.S. Cl. 180/65.1

(57) ABSTRACT

A motorized all-terrain hauling vehicle includes a drive track assembly [22] and a flat bed [12] suspended above the drive track assembly. The flat bed [12] has an anterior portion, a motor assembly [28, 38] coupled to the anterior portion of the flat bed [12], a gear reduction assembly [23] coupled to the drive track assembly [22], and a steering handle bar [24] with a handle base [25] coupled to the back end of the anterior portion of the flat bed [12] enabling the hauling assembly [10] to haul large or bulky cargo loads over soft surfaces and rough terrain, especially ice, mud and snow.

### BACKGROUND

The invention relates generally to an all-terrain device for hauling large cargo in and more particularly relates to a motorized hauling apparatus having drive tracks.

The use of hauling devices having a ski-track assembly is generally known. For example U.S. Pat. No. 5,911,422 teaches the use of a non-motorized wheeled carrier suitable for carrying diverse articles on sandy terrain. The carrier has four wheels supported on brackets and axles suspended beneath the body. Each wheel has an associated skid pivotally supported on the axle supporting its associated wheel. Each skid is configured in the manner of a ski, for assisting the carrier in negotiating ridges and similar obstructions present in sandy terrain.

It is also known to use a drive track on a snowmobile for having a mobile ice fishing shelter assembly for permitting quick and easy movement of a mobile shelter designed to facilitate ice fishing. For example, U.S. Pat. No. 6,962,221 teaches a mobile ice fishing shelter assembly positionable on a vehicle having a seat portion and a drive assembly, and may comprise a shelter assembly coupled to the vehicle.

There remains a need for a low cost all-terrain motorized cargo hauling vehicle. It would be desirable to have a low cost solution to this need.

### BRIEF DESCRIPTION

Briefly, in accordance with one embodiment of the present invention, an all-terrain hauling appartus comprises a drive track assembly having a flat bed and/or a cargo container suspended above the drive track assembly. The flat bed has an anterior portion, a motor assembly coupled to the anteror portion of the flat bed, a gear reduction assembly coupled to the drive track assembly and to the motor assembly, and a steering handle bar with a handle base coupled to the back end of the anterior portion of the flat bed, enabling the hauling assembly is haul cargo loads over all terrain.

The gear reduction assembly has a first pulley coupled via a belt to the motor assembly, a second pulley coupled via a motor drive shaft to the first pulley and coupled via a second belt to the drive track assembly so as to drive the drive track assembly at slow speeds.

Further, the steering handle bar may have a telescoping base which enables it to be retracted and extended. The drive track assembly may have a pivot point to enable ease of turning during operation. Finally, the motor assemble may be an electric motor or a gas driven motor.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of the hauling apparatus of the present invention.

FIG. 2 is a perspective view of an alternative embodiment of the hauling apparatus of the present invention.

### DETAILED DESCRIPTION

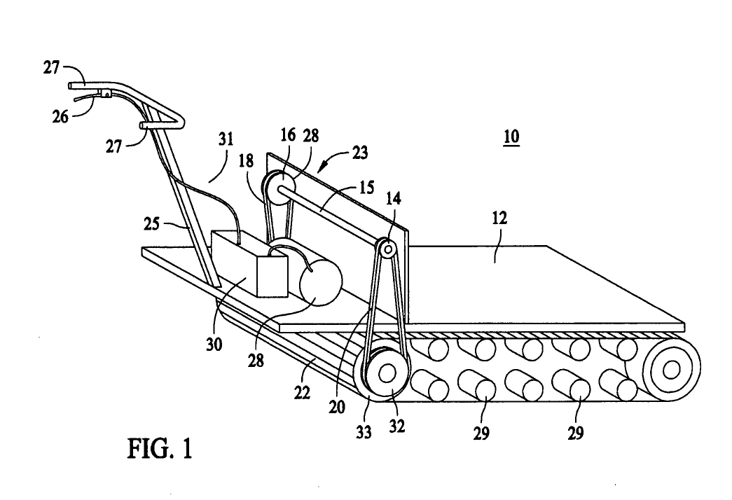

The present invention is a motorized large cargo hauling vehicle having the ability to haul such cargo over all-terrain. In an exemplary embodiment of the present invention FIG. 1 is a motorized hauling assembly 10 comprising, a flat bed 12 suspended over a drive track assembly 22. Flat bed 12 and drive track assembly 22 may be the same assembly typically found on a convention gas powered passenger snow mobile which is herein incorporated by reference. The conventional seat, gas engine, steering skis and associated steering mechanism is removed. A motor assembly comprising an electric motor 28, a battery 30, a motor speed control 26, and cable 31 electrically coupling each of these devices together, is coupled to the flat bed 12. The battery 30 may be one or more batteries coupled in series or in parallel. Electric motor 28, which may be rated at 3 horsepower (hp), is fixed to the anterior portion of flat bed 12. A gear reduction assembly comprising a motor pulley (not shown) rotatingly coupled to the shaft (not shown) of motor 28, a second gear pulley 16 rotatingly coupled to the motor 28 via a first belt 18, a motor drive shaft 15 rotatingly coupled to pulley 16 and third gear pulley 15, belt 20 rotatingly coupled to third pulley 14 and to drive track gear 33. A steering handle bar 24 having a base 25 is fixedly coupled near the end of the anterior portion of flat bed 12. Speed control 26 is coupled to the end of steering handle bar 24 which may have gripping ends 27 for ease of motor speed control during operation. Speed control 26 may be a voltage varying switch assembly.

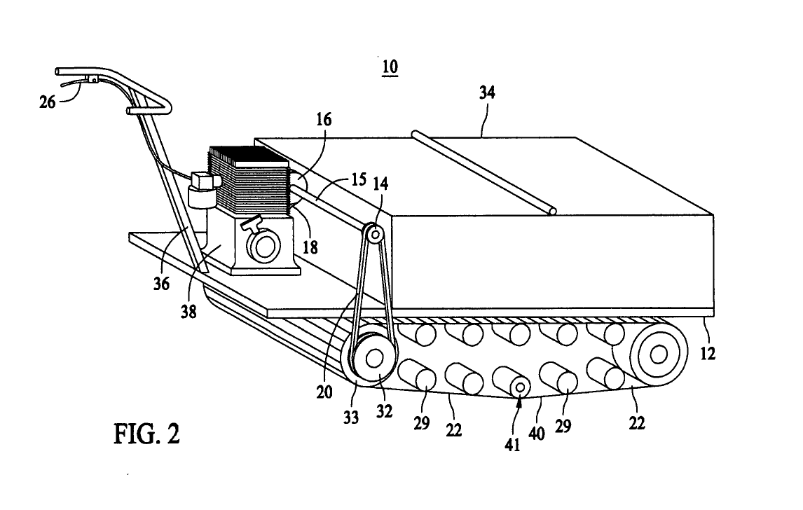

In another exemplary embodiment of the present invention, as illustrated in FIG. 2, the base of the steering handle bar 25 may by telescoping so that the handle bar 24 is retractable. This enables the height of the hauling apparatus 10 to be decreased for transport or storage. Further the drive track assembly 22 may have a pivoting track guide 40 so that the drive track is adapted to have a pivot point 41 near the bottom mid section. This enables hauling apparatus 10 to be more easily maneuvered during turning while hauling heavy loads. Pivoting track guide 40 is in a horizontal plane along and parallel to flat bed 12 which is lower than the horizontal plane of the other track guides 29. Such positioning enables drive track assembly 22 to have pivot point 41. If the hauling apparatus 10 was on a hard dry surface, such as pavement, it would be difficult to turn if the track assembly 22 was flat on the pavement. However, by introducing a slightly protruding center portion of the track, the vehicle may be pivoted on this slightly protruding portion allowing easier steering.

Further flat bed 12 may have an enclosure 34 which makes it easier to haul bulky items. The enclosure 34 may have a plurality of compartments for storage. These compartments may, for example, be used to haul, fish and bait. Each compartment may be open or closed.

Even though FIG. 2 shows an extended portion of track 22 across the middle of the track at roller 41 from side to side, please note that it is within the scope of the invention to have an extended portion of track 22 from front to back on track 22. This may be accomplished by having individual rollers which extend out further than the others at the desired locations. With this extended portion, a user may simply bank the hauling apparatus 10 to the side in which they would like to turn.

It is also within the scope of the invention to have an extended ‘mound’ somewhere in the bottom of track 22 for the same reasons. This will allow banking of the hauling apparatus 10 and easier turning on hard, dry surfaces.

They also may be used to carry heavy building materials on a construction site. Typically, the ground is soft mud and there are heavy, bulky materials which need to be moved from place to place.

In another alternative embodiment the motor assembly is a gas powered motor 38 having a speed control 26. The motor 28 has a motor pulley (not shown) coupled to its shaft. The speed control 26 is mechanically coupled to the gas powered motor 28 to control the speed. The motor may be as little as 3 hp, and can be selected based on the size of the load that may be hauled. In the present exemplary embodiment the load may be up to 500 pounds base on a 3 horse gas power motor.

The operation of the present hauling apparatus 10 is straight-forward. The vehicle operator walks behind the motorized vehicle and operating the speed control to determine the speed of the vehicle. The steering wheel bar 24 may be turned to the right or left during vehicle movement which causes the hauling apparatus to maneuver to the corresponding opposite right or left. The gear reduction assembly has a gear reduction ratio so that the hauling apparatus 10 travels at 0 to 6 miles per hour over the full throttle range. For example, one embodiment may have a gear reduction of 25 to 1. The center of gravity of the flat bed 12 is low in comparison to the drive track assembly, which enables the present invention to haul large loads over any terrain.

The previously described embodiments of the present invention have many advantages, including the ability to haul heavy or bulky cargo on all-terrain including terrain such as frozen lakes, on non-paved surfaces, in rocky areas and on slippery surfaces, such as snow and ice and mud. The present invention can carry very large loads without exceeding the point loading of a surface. Since the tracks make have 12 square feet of surface area, as opposed to a few square inches for wheels, the maximum loading (lbs./square inch) on a surface is much lower than would be for wheels. The lower loading per square inch allows the present invention to carry large loads over soft or deformable surfaces without destroying the surfaces.

For exampled, the present invention can haul up to 500 pound loads across frozen lakes and up steps. Because the present invention is based on existing snowmobile drive track technology it is cheaper to manufacture.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An all-terrain hauling appartus having a drive track assembly comprising:
a flad bed suspended above the wheeled track assembly, said flat bed having an anterior portion;
a motor assembly coupled to the anteror portion of said flat bed;
a gear reduction assembly rotatably coupled to the drive track assembly and to said motor assembly; and
a steering handle bar having a handle base coupled to the all-terrain hauling vehicle, wherein said hauling apparatus is adapted to haul cargo loads.

2. The all-terrain hauling apparatus as recited in claim 1, wherein said gear reduction assembly comprises a first pulley movingly coupled to said motor assembly, a second pulley movingly coupled to said first pulley and movingly coupled to said drive track assembly.

3. The all-terrain hauling appartus as recited in claim 2, wherein said motor assembly comprises an electric motor, a batterty, and a motor control all electrically coupled together, wherein said electric motor is adapted to drivingly engage said drive track assembly.

4. The all-terrain hauling appartus as recited in claim 2, wherein said motor assembly comprises a gas powered engine having a motor control, wherein said motor control is mechanically coupled to said gas power engine, and said motor assembly is adapted to drivingly engage said drive track assembly.

5. The all-terrain hauling appartus as recited in claim 1, wherein said steering handle bar is adapted to control the steering of said hauling appartus.

6. The all-terrain hauling appartus as recited in claim 5, wherein said steering handle bar comprises griping ends, a telescoping base fixedly coupled to said steering handle bar and fixedly coupled near the end of the anterior portion of said flat bed.

7. The all-terrain hauling appartus as recited in claim 5, wherein said motor control is coupled to said steering handle bar near said gripping ends.

8. The all-terrain hauling appartus as recited in claim 1, further comprising a enclosure covering the base, wherein the enclosure is divided into a plurality of compartments and adapted to carry cargo.

9. The all-terrain hauling appartus as recited in claim 2, wherein said drive track assembly futher compises a track pivot guide near the center and at the bottom of the drive track in a plane that is below the plane of the track guides so as to cause said drive track assembly to have a pivot point where the tracks movingly engages track pivot guide to aid in steering said hauling appartus.

10. A motorized hauling vehicle having a drive track assembly comprising:
a flad bed suspended above the drive track assembly, said flat bed having an anterior portion;
a motor assembly coupled to the anteror portion of said flat bed;
a gear reduction assembly rotatably coupled to the drive track assembly and to said motor assembly, wherein said gear reduction assembly comprises a first pulley movingly copuled to said motor assembly, a second pulley movingly coupled to said first pulley via a motor drive shaft and movingly coupled to said drive track assembly; and
a steering bar coupled to the motorized hauling vehicle allowing a user to pivot hauling vehicle to steer it in a desired direction.

11. The motorized hauling vehicle as recited in claim 10, wherein said steering handle bar comprises griping ends, a telescoping base fixedly coupled to said steering handle bar and fixedly coupled near the end of the anterior portion of said flat bed.

12. The motorized hauling vehicle as recited in claim 10, wherein said motor assembly comprises an electric motor, a batterty, and a motor control all electrically coupled together wherein said electric motor is adapted to drivingly engage said drive track assembly.

13. The motorized hauling vehicle as recited in claim 10, wherein said motor assembly comprises a gas powered engine having a motor control, wherein said motor control is mechanically coupled to said gas power engine, and said motor assembly is adapted to drivingly engage said drive track assembly.

14. The motorized hauling vehicle as recited in claim 10, wherein said steering handle bar is adapted to control the steering of the motorized hauling vehicle.

15. The motorized hauling vehicle as recited in claim 13, wherein said drive track assembly futher compises a track pivot guide near the center and at the bottom of the drive track assembly in a plane that is below the plane of the track guides so as to cause said drive track to have a pivot point where the tracks movingly engages track pivot guide to aid in steering the motorized hauling vehicle.

16. A motorized hauling vehicle having a drive track assembly comprising:
a flad bed suspended above the wheeled track assembly said flat bed having an anterior portion;
a motor assembly coupled to the anteror portion of said flat bed, wherein said motor assembly comprises a gas powered engine having a motor control, wherein said motor control is mechanically coupled to said gas power engine, and said motor assembly is adapted to drivingly engage said drive track assembly;
a gear reduction assembly rotatably coupled to the drive track assembly and to said motor assembly for transmitting power from the motor assembly to said drive track assembly; and
a steering bar coupled to the hauling vehicle allowing a user to pivot hauling vehicle to steer it in a desired direction.

17. The motorized hauling vehicle as recited in claim 16 wherein said gear reduction assembly comprises a first pulley movingly copuled to said motor assembly, a second pulley movingly coupled to said first pulley via a motor drive shaft and movingly coupled to said drive track assembly; and

18. The motorized hauling vehicle as recited in claim 16 wherein the steering bar comprises griping ends, a telescoping base fixedly coupled to said steering handle bar and fixedly coupled near the end of the anterior portion of said flat bed.

19. The motorized hauling vehicle as recited in claim 16, wherein said motor assembly comprises an electric motor, a battery, and a motor control all electrically coupled together, wherein said electric motor is adapted to drivingly engage said drive track assembly.

20. The motorized hauling vehicle as recited in claim 16, wherein said motor control is coupled to said steering handle bar near said gripping ends.

21. The motorized hauling vehicle as recited in claim 16, further comprising a enclosure covering the base, wherein the enclosure is divided into a plurality of compartments and adapted to carry cargo.

22. The motorized hauling vehicle as recited in claim 16, wherein said drive track assembly futher compises a track pivot guide near the center and at the bottom of the drive track in a plane that is below the plane of the track guides so as to cause said drive track assembly to have a pivot point where the tracks movingly engages track pivot guide to aid in steering the motorized hauling vehicle.

23. The motorized hauling vehicle as recited in claim 20, wherein at least one of said plurality of compartments is enclosed.
